(19) United States
(12) Patent Application Publication
(10) Pub. No.: US 2020/0219436 A1
(43) Pub. Date: Jul. 9, 2020

(54) ARRANGEMENT FOR OPERATING OPTOELECTRONIC SEMICONDUCTOR CHIPS AND DISPLAY DEVICE

(71) Applicant: OSRAM OLED GmbH, Regensburg (DE)

(72) Inventors: Frank SINGER, Regenstauf (DE); Thomas SCHWARZ, Regensburg (DE); Thorsten Frank BAUMHEINRICH, Altdorf (DE); Hubert HALBRITTER, Dietfurt (DE)

(21) Appl. No.: 16/648,812

(22) PCT Filed: Sep. 20, 2018
(86) PCT No.: PCT/EP2018/075462

§ 371 Date: Mar. 19, 2020

(30) Foreign Application Priority Data
Sep. 22, 2017 (DE) 10 2017 122 014.3

(51) Int. Cl. G09G 3/32

(52) U.S. Cl. CPC G09G 3/32; G09G 2310/08; G09G 2310/0275; G09G 2300/0852

(57) ABSTRACT

An arrangement includes a semiconductor chip with a first and second electrode. The arrangement also includes a control unit for adjusting a current for operating the semiconductor chip, a first LED voltage input coupled to the first electrode, and a reference voltage input coupled to the second electrode. The arrangement further includes an LED data input coupled to the control unit, by which a data parameter representative of a current for operating the semiconductor chip is provided. The arrangement additionally includes a cycle input coupled to the control unit, by which a reference cycle signal is provided which is representative of an operating phase of the arrangement. The control unit includes a memory arranged to record the data parameter as a memory value depending on the reference cycle signal. The control unit is configured to adjust the current depending on the memory value.

This patent application claims the priority of the German patent application DE 102017122014.3, the disclosure content of which is hereby incorporated by reference.

The invention relates to an arrangement for operating optoelectronic semiconductor chips and to a display device.

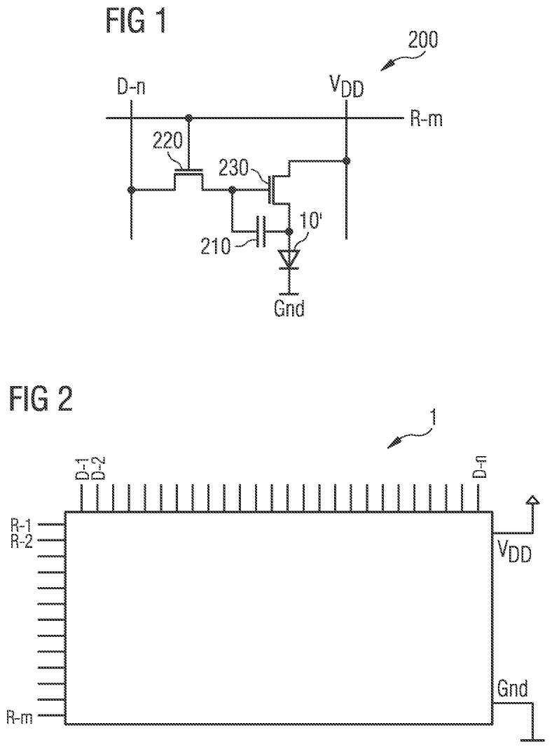

Modern display devices often have an active matrix circuitry. As an example, a large number of organic LEDs 10′ (FIG. 1) are arranged herein in rows and columns in a matrix-like manner, each representing a picture element (pixel) 200 of the display device. A capacitor 210, a switching transistor 220 and a driver transistor 230 are assigned to each picture element 200 for controlling. In addition, each picture element 200 is assigned a data line Dn, a switching line Rm and two supply lines V_{DD}, Gnd. The switching transistor 220 is configured to apply a voltage to capacitor 210 and thus charge or discharge it. Capacitor 210 is configured to provide a voltage controlling the driver transistor 230, which in turn can be used to adjust a current through the driver transistor 230 and the organic LED 10′.

Leakage currents can cause capacitor 210 to discharge over time. In addition to the brightness of the organic LEDs 10′, their emission wavelength and thus the color location is also adjusted by the current, which leads to a reduction in the image quality of the display device.

The task underlying the invention is to create an arrangement as well as a display device which contribute to a color location stable active-matrix operation of an optoelectronic semiconductor chip. In particular, the aim is to enable active-matrix operation of inorganic LEDs with stable chromaticity coordinates.

The problem is solved by the subject-matter of the independent patent claims. Advantageous embodiments of the respective subject-matter are marked in the corresponding subclaims.

According to a first aspect, the invention concerns an arrangement for operating optoelectronic semiconductor chips. The arrangement can be used especially in a display device. The arrangement or several such arrangements can form a unit. As an example, the arrangement forms a picture element of the display device.

In an advantageous embodiment according to the first aspect, the arrangement comprises a first semiconductor chip with a first and second electrode, which is configured to emit electromagnetic radiation during operation. Deviating from this, the arrangement may in particular include more than one optoelectronic semiconductor chip. For example, the arrangement may include several semiconductor chips, each of which is designed to emit light of a different color. For example, the semiconductor chip is a light-emitting diode (LED), especially an inorganic LED.

In an advantageous embodiment according to the first aspect, the arrangement comprises a control unit for adjusting a current for operating the first semiconductor chip. Depending on the number of semiconductor chips assigned to the arrangement, the control unit can also be configured to adjust a respective current for operating several semiconductor chips, in particular all semiconductor chips assigned to the arrangement. The control unit is a digital circuit, for example an integrated circuit in CMOS or TFT technology.

In an advantageous embodiment according to the first aspect, the arrangement comprises a first LED voltage input coupled to the first electrode of the first semiconductor chip and a reference voltage input coupled to the second electrode of the first semiconductor chip via the control unit. Depending on the number of semiconductor chips assigned to the arrangement, the first LED voltage input or the reference voltage input can also be coupled to the respective electrodes of several semiconductor chips, in particular all semiconductor chips assigned to the arrangement. For example, the first electrode can be a cathode and the second electrode can be an anode of the first semiconductor chip (so-called “low side driver”). Alternatively, the first electrode can be the anode and the second electrode the cathode of the first semiconductor chip (so-called “high side driver”). In both cases, the reference voltage input can carry ground potential for example.

In an advantageous embodiment according to the first aspect, the arrangement comprises an LED data input coupled to the control unit and providing a data parameter representative of a current for operating the first semiconductor chip.

For example, the current for operating a semiconductor chip may include or denote a variable pulse width and/or a variable current intensity. In particular, the data parameter can thus be representative of an average current intensity for operating the semiconductor chip or an associated brightness of the radiation emitted by the semiconductor chip to be adjusted.

The fact that a signal or a parameter can be provided via an input or output here and in the following indicates that the corresponding input or output is intended for signal coupling with a corresponding further (signal processing) unit and is configured to receive the respective signal or the respective parameter from such a unit or to send it to it.

As an example, the data parameter represents one or more pulse widths of the current for operating the first semiconductor chip. Depending on the number of semiconductor chips allocated to the arrangement, the data parameter may also be representative of a corresponding current for operating several semiconductor chips, in particular all semiconductor chips allocated to the arrangement. For example, the data parameter can be representative of a brightness to be set for individual LEDs or in combination for a color to be set for the radiation emitted by the arrangement.

In an advantageous embodiment according to the first aspect, the device comprises a cycle input coupled to the control unit and via which an external reference cycle signal representative of an operating phase of the arrangement can be provided. The reference cycle signal is particularly representative of the fact that a valid data parameter is present at the LED data input assigned to the arrangement.

In an advantageous embodiment according to the first aspect, the control unit includes a memory. The memory has a storage capacity >3 bits and is configured to record the data parameter as memory value depending on the reference cycle signal. Depending on the number of semiconductor chips assigned to the arrangement, the memory may comprise several memory units, each assigned to one semiconductor chip. In particular, the memory comprises one memory unit per semiconductor chip and/or color channel of the arrangement. For example, each memory unit has a storage capacity of 8 bit, 10 bit or 16 bit. In particular, the memory is a digital memory. The memory or memory units can be designed as flipflops, for example. In particular, the memory units can form a shift register for serial recording of the data parameter. In this context, the memory may comprise one or more upstream or downstream buffer units.

In an advantageous embodiment according to the first aspect, the control unit is configured to adjust the current for operating the first semiconductor chip depending on the memory value. Depending on the number of semiconductor chips assigned to the arrangement, the control unit can also be configured to adjust the corresponding current for operating several semiconductor chips, in particular all semiconductor chips assigned to the arrangement.

In an advantageous embodiment according to the first aspect, the arrangement comprises a first semiconductor chip with a first and second electrode, which is configured to emit electromagnetic radiation during operation. The arrangement further comprises a control unit for adjusting a current for operating the first semiconductor chip, a first LED voltage input coupled to the first electrode of the first semiconductor chip, and a reference voltage input coupled to the second electrode of the first semiconductor chip via the control unit. In addition, the arrangement includes an LED data input coupled to the control unit, and via which a data parameter can be provided which is representative of a current for operating the first semiconductor chip. Furthermore, the arrangement comprises a cycle input which is coupled to the control unit and via which a reference cycle signal external with respect to the arrangement can be provided which is representative of an operating phase of the arrangement. The control unit comprises a memory with a storage capacity >3 bits and is configured to record the data parameter as memory value depending on the reference cycle signal. The control unit is configured to adjust the current for operating the first semiconductor chip depending on the memory value.

With regard to an active-matrix circuitry as described in FIG. 1, such an arrangement allows the semiconductor chip(s) to be controlled mostly digitally. By using digital signals, the arrangement is advantageously less susceptible to interference than with analog signals. By storing the data parameter in the arrangement, a number of lines to the arrangement required to operate it in a display device can be kept low. With an analog design, however, a separate data line would be required for each color channel. The memory also allows dead times in the refresh cycle, i.e. per operating phase of the arrangement, to be kept low or practically avoided, since new data parameter can be written to the memory parallel to the operation of the respective semiconductor chips. This can prevent flickering of the arrangement and thus contribute to an increased image quality of the display device. It is advantageous to use the memory to prevent data from being lost or corrupted due to leakage currents. Furthermore, in this context it is not necessary to write new data parameters with each refresh cycle, since a data parameter assigned to the arrangement can be held as memory value for any length of time. If only minor changes are made to an image content intended for display on a display device, a data rate for the transmission of data parameters can therefore be kept low. This contributes to low power consumption and advantageous high frequency compability.

In an advantageous embodiment according to the first aspect, the first semiconductor chip is configured to emit red light. In addition, the arrangement comprises a second semiconductor chip with a first and second electrode, which is configured to emit green light during operation, and a third semiconductor chip with a first and second electrode, which is configured to emit blue light during operation. Furthermore, the arrangement includes a second LED voltage input, which is coupled to the first electrode of the second and third semiconductor chips. The reference voltage input is coupled to the second electrode of the semiconductor chips via the control unit. Here the data parameter is representative of a current for operating the respective semiconductor chip and the control unit is configured to adjust the current for operating the respective semiconductor chip depending on the memory value.

A supply voltage applied to the first LED voltage input can be between 2 V and 3 V inclusive, in particular 2.5 V. A supply voltage applied to the second LED voltage input can be between 3 V and 4 V inclusive, especially 3.5 V. This enables the semiconductor chips to be operated particularly efficiently.

In addition, the arrangement can have an additional IC voltage input to supply the control unit. A supply voltage applied to the IC voltage input can be between 1 V and 2.5 V inclusive, in particular 1.8 V. Alternatively, the arrangement may include a voltage converter for converting the supply voltage applied to one of the LED voltage inputs to a voltage between 1 V and 2.5 V inclusive, in particular 1.8 V. This is an advantageous way of keeping the number of lines required to operate the arrangement low.

In an advantageous embodiment according to the first aspect, the control unit comprises one counter per semiconductor chip. The counter has a clock input via which a reference clock signal can be provided and a data input coupled to the memory. The counter is designed to take an initial counter value depending on the memory value and to count with the respective counter value depending on the reference clock signal up to a predetermined final value. The control unit is configured to adjust the current for operating the respective semiconductor chip depending on the corresponding counter value.

In an advantageous way, a pulse width of the current for operating the respective semiconductor chip can be adjusted depending on the corresponding counter value.

The counter is a digital counter. In particular, a separate counter may be assigned to each semiconductor chip and/or color channel of the arrangement. As an example, the counter may take the memory value as initial counter value per refresh cycle. For example, the counter can be designed as a decrementing counter and, for example, decrement the counter value to the predetermined final value, for example zero, for each rising edge of the reference clock signal. Deviating from this, it is also conceivable to design the counter as an up-counter and to count from an initial counter value, e.g. zero, to the memory value as a predefined final value.

In an advantageous embodiment according to the first aspect, the arrangement further comprises a comparator and a switch per semiconductor chip. The comparator is coupled to the respective counter and is configured to compare the respective counter value with the predetermined final value. The control unit is configured to set the switch to a first switching state if the predetermined final value has not yet been reached, and to set the switch to a second switching state if the predetermined final value has been reached. The switch is configured to couple or decouple the respective second electrode of the semiconductor chips with the reference voltage input, depending on the respective switching state, and thus adjust the current for operating the respective semiconductor chip.

For example, the switch is a transistor which is switched by an output signal of the comparator. In particular, the switch is configured to set the semiconductor chips in the first switching state to light-emitting operation and in the second switching state to a switched-off operating state.

In an advantageous embodiment according to the first aspect, the control unit is configured to reset the respective counter depending on an initiator signal. The initiator signal can be an external signal supplied via an extra line. Furthermore, a signal externally supplied with respect to the arrangement can be used for this purpose via one of the described connections, which is decoupled by capacitive decoupling, as for example a negative voltage pulse. As an example, the externally supplied signal is a high-frequency signal that is modulated onto a DC voltage component fed through the connector and separated from the DC voltage component by a capacitor or RC element. Alternatively, the arrangement can include an additional counter that counts up to a predetermined final value depending on the reference clock signal, for example 255 for an 8 bit counter, and generates the initiator signal via an AND gate. It is also conceivable to generate the initiator signal from the first rising edge of the reference cycle signal, for example.

In an advantageous embodiment according to the first aspect, the control unit is configured to reset the respective counter depending on the reference cycle signal and the memory value. In particular, the control unit can be configured to write the memory value to the counter as an initial counter value for each refresh cycle.

In an advantageous embodiment according to the first aspect, the control unit has a reference clock generator for generating the reference clock signal, which is coupled to the clock input of the respective counter. The reference clock generator can be a ring oscillator as an example.

In an advantageous embodiment according to the first aspect, the arrangement comprises a reference clock input which is coupled to the clock input of the respective counter and via which a reference clock signal external with respect to the arrangement can be provided.

In an advantageous embodiment according to the first aspect, the control unit has a supply input coupled to the first LED voltage input.

In an advantageous embodiment according to the first aspect, the arrangement also includes an IC voltage input. The control unit has a supply input coupled to the IC voltage input.

In an advantageous embodiment according to the first aspect, the control unit comprises one shift register per semiconductor chip. The shift register has a clock input via which a PWM clock signal can be provided. Furthermore, the shift register has a data input, which is coupled to the memory, and a data output. The shift register is configured to receive an initial shift value depending on the memory value, to shift the respective shift value bit by bit depending on the PWM clock signal and to output it as control value via the data output. The control unit is configured to adjust the current for operating the respective semiconductor chip depending on the corresponding control value.

The shift register is connected downstream of the memory, especially instead of the counter. In an advantageous way, the bit-by-bit provision of the control value by the PWM clock signal enables a pulse width modulation of the current to operate the respective semiconductor chip per refresh cycle. Accordingly there is no pulse width modulation of the supply voltage applied to the LED voltage input, but rather a pulse width modulation, dependent on the data parameter, of a control signal which is local or individual with respect to the arrangement for adjusting the current for operating the respective semiconductor chip, for example a control signal for switching a switch described as follows. In this context, the PWM clock signal may have pulse widths that double cyclically, for example.

In an advantageous embodiment according to the first aspect, the arrangement comprises a switch per semiconductor chip, which is coupled to the data output of the respective shift register. The control unit is configured to set the switch to a first or second switching state depending on the control value. The switch is configured to couple or decouple the respective second electrode of the semiconductor chips with the reference voltage input, depending on the respective switching state, and thus adjust the current for operating the respective semiconductor chip.

For example, the switch is a transistor which is switched by the control value output by the shift register.

In an advantageous embodiment according to the first aspect, the arrangement comprises a PWM clock input which is coupled to the clock input of the respective shift register and via which a PWM clock signal external to the arrangement can be provided.

In an advantageous embodiment according to the first aspect, the control unit includes a PWM clock generator. The PWM clock generator has a clock input via which a reference clock signal can be provided. The PWM clock generator is configured to generate the PWM clock signal depending on the reference clock signal and is coupled to the clock input of the respective shift register.

The reference clock signal can, for example, be provided externally with respect to the arrangement, for example via a reference clock input analogous to the above-mentioned, or it can be generated internally, for example by a reference clock generator analogous to the above-mentioned.

In an advantageous embodiment according to the first aspect, the control unit has a reference clock generator for generating the reference clock signal, which is coupled to the clock input of the PWM clock generator. The reference clock can be a ring oscillator as an example.

In an advantageous embodiment according to the first aspect, the arrangement comprises a reference clock input which is coupled to the clock input of the PWM clock generator and via which a reference clock signal external with respect to the arrangement can be provided.

In an advantageous embodiment according to the first aspect, the control unit is configured to reset the PWM clock generator depending on the reference cycle signal. As an example, the control unit is configured to reset the PWM clock generator when the reference cycle signal is inactive.

In an advantageous embodiment according to the first aspect, the shift register is designed as a circular shift register. In this way, it is advantageous to dispense with a buffer upstream the shift register.

In an advantageous embodiment according to the first aspect, the control unit is configured to determine a control signal depending on the PWM clock signal and the reference cycle signal. The control unit is also configured to reset the shift value depending on the control signal and to record the memory value as initial shift value in the corresponding shift register.

For example, the PWM clock generator generates a first control signal, for example after output of the last pulse per refresh cycle. The first control signal can be used as a control signal to trigger the internal programming of the shift register, for example. Alternatively, depending on the first control signal and an external control signal, a second control signal can be determined, which can be used as a control signal to trigger the internal programming of the shift register. The external control signal can be the reference cycle signal, for example. The second control signal can be generated, for example, as the output signal of an AND-gate, which has as inputs the first control signal and the output signal of an XOR-gate with the first control signal and the external control signal as inputs.

In an advantageous embodiment according to the first aspect, the data parameter includes a dimming parameter for operating the respective semiconductor chip. The memory also has a dimming memory area for receiving the dimming parameter. The control unit is configured to scale the current for operating the respective semiconductor chip depending on the dimming parameter.

The current can be scaled by controlling several current sources, which are connected in series per semiconductor chip and configured to provide one current each to operate the respective semiconductor chip. In particular, the current sources are designed to provide a binary staggered current, i.e. the current of successive current sources has a ratio of 1:2:4:8:16:32, etc. Each bit of the dimming memory area can be used to control a current source.

In an advantageous embodiment according to the first aspect, the control unit is configured to detect a voltage level applied to the first and/or second LED voltage input and/or to the cycle input and/or to the reference clock input. Furthermore, the control unit is configured to record a data parameter present at the LED data input as dimming parameter in the dimming memory area in the event of a predetermined deviation of the voltage level from a predetermined standard operating voltage level.

The above-mentioned operating voltages between 1 V and 5 V inclusive can be considered as the predetermined standard operating voltage level. The predetermined deviation can be, for example, a voltage level that is half the respective standard operating voltage level. In an advantageous way, data for the adjustment of gray levels and brightness of the arrangement can be transmitted independently of each other.

In an advantageous embodiment according to the first aspect, the memory has an input memory unit and an output memory unit. The input memory unit is coupled to the LED data input on the input side for receiving the data parameter as a buffer value. In addition, the input memory unit is coupled to an input of the output memory unit via an exclusive-or-gate on the output side for outputting the buffer value. The output memory unit is configured to receive the buffer value output via the exclusive-or-gate as memory value and to provide it on the output side for operating the respective semiconductor chip.

This allows a reduction of the data rate for the transmission of the data parameter in an advantageous way. In particular, the data parameter can then be representative of changes in the light to be emitted by the arrangement, instead of specifying an absolute control value per refresh cycle. In this way a load on the corresponding data line can be kept low. For example, if the logic of a display device comprising the arrangement is positive, the data parameter logically “1” represents a change in the stored memory value, thus enabling low bus loads. Alternatively, the data parameter logical “0” can also represent a change in the stored memory value.

In an advantageous embodiment according to the first aspect, the memory forms a shift register per semiconductor chip. The shift register has a clock input, via which a PWM clock signal can be provided, a data input for receiving the data parameter as memory value and a data output. The shift register is configured to shift the memory value bit by bit depending on the PWM clock signal and to output it as control value via the data output. The control unit is configured to adjust the current for operating the respective semiconductor chip depending on the corresponding control value. This allows an active matrix operation with synchronous serial programming without pause in an advantageous way, where only one memory unit or shift register per semiconductor chip is required.

According to a second aspect, the invention concerns a display device. The display device comprises a plurality of arrangements according to the first aspect arranged in rows and columns in a matrix-like manner. In addition, the display device comprises a first and second supply line as well as a data line per column and a switching line per row. The arrangements are each coupled by their first LED voltage input to the first supply line and by their reference voltage input to the second supply line. Furthermore, the LED data input of each arrangement is coupled to the respective data line and its cycle input to the respective switching line.

In an advantageous embodiment according to the second aspect, the display device includes a third supply line. The arrangements are each coupled by their second LED voltage input to the third supply line. This allows the display device to be operated particularly efficiently.

In an advantageous embodiment according to the second aspect, the display device includes a fourth supply line. The arrangements are each coupled by their IC voltage input to the fourth supply line. This allows the display device to be operated particularly efficiently.

In an advantageous embodiment according to the second aspect, the display device comprises at least one PWM clock generator for providing a PWM clock signal. The at least one PWM clock generator is associated with one or more arrangements.

In an advantageous embodiment according to the first or second aspect, the PWM clock generator includes one or more flipflops connected in series, a multiplexer and a counter. The multiplexer has at least one control input, at least two inputs and one output. The flipflop(s) is (are) configured to output a clock pulse present on the input side halved on the output side.

The one flipflop is coupled on the input side with the reference clock signal and a first input of the multiplexer. On the output side, the one flipflop is coupled to a second input of the multiplexer.

Alternatively, a first of several flipflops is coupled on the input side with the reference clock signal as well as the first input of the multiplexer. On the output side, the first of the plurality of flipflops is coupled to an input of a second flipflop of the plurality of flipflops and to a second input of the multiplexer, the second flipflop being coupled on the output side in turn to a further input of the multiplexer. In addition, the second flipflop on the output side can also be coupled to several other inputs of the multiplexer via one or more flipflops connected in series.

The output of the multiplexer is coupled to a clock input of the counter and is representative of the PWM clock signal.

The counter is configured to increment a control signal present at the at least one control input in binary form, depending on the PWM clock signal.

Such a PWM clock generator is advantageous for easy and precise generation of the PWM clock signal described above. In particular, such a PWM clock signal can have pulse widths that cyclically double.

Exemplary embodiments of the invention are explained in more detail below on the basis of the schematic drawings.

It is shown:

FIG. 1 an exemplary picture element of a display device in active matrix operation;

FIG. 2 an exemplary display device;

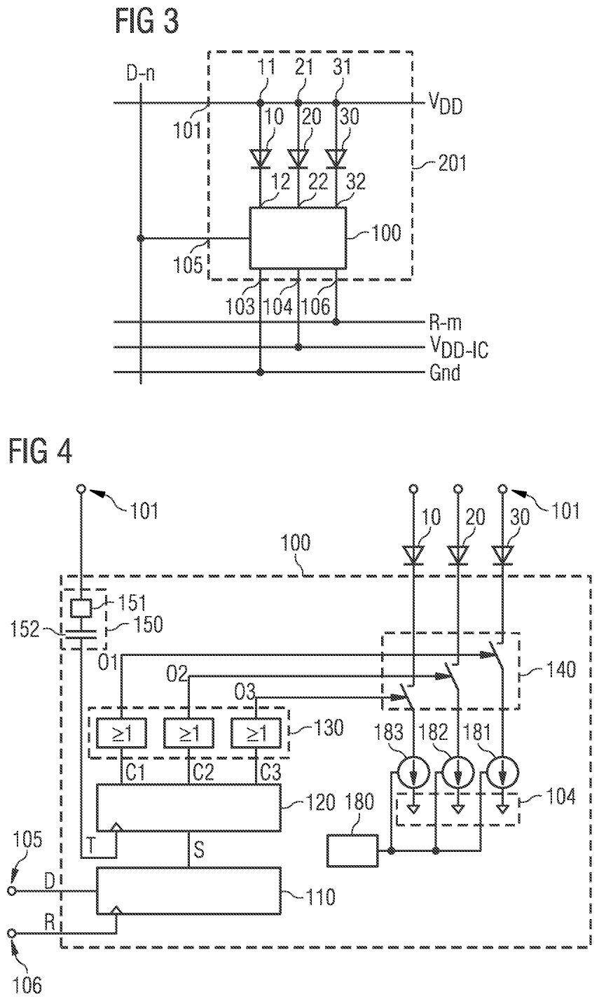

FIG. 3 a first exemplary embodiment of an arrangement for operating optoelectronic semiconductor chips;

FIGS. 4-5 a first exemplary embodiment of a control unit of the arrangement according to FIG. 3 in detail view;

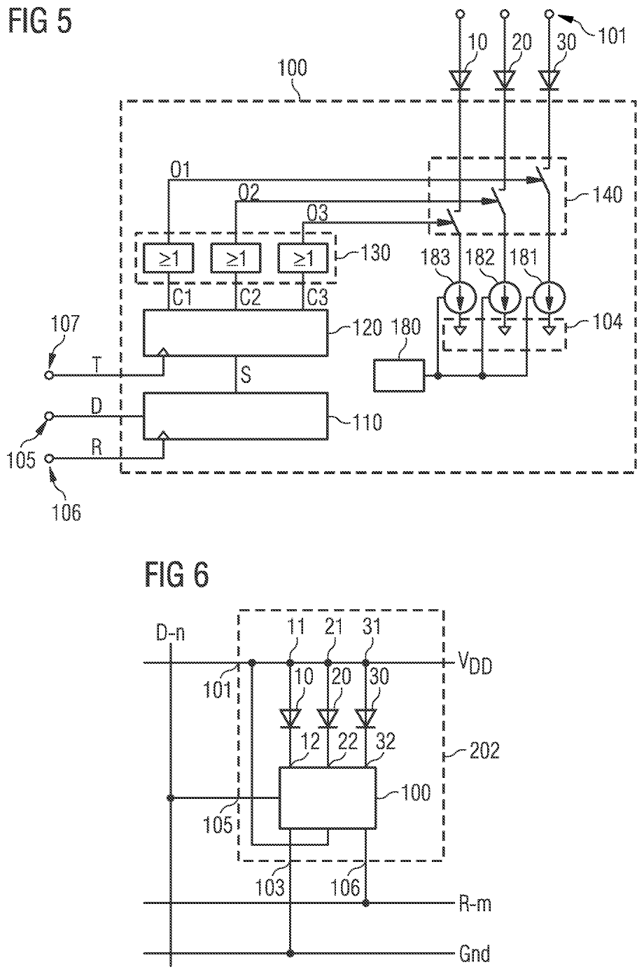

FIG. 6 a second exemplary embodiment of an arrangement for operating optoelectronic semiconductor chips;

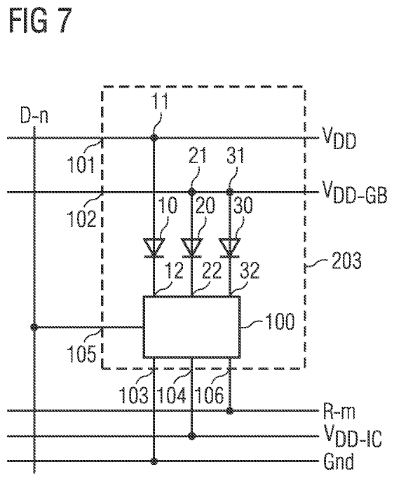

FIG. 7 a third exemplary embodiment of an arrangement for operating optoelectronic semiconductor chips;

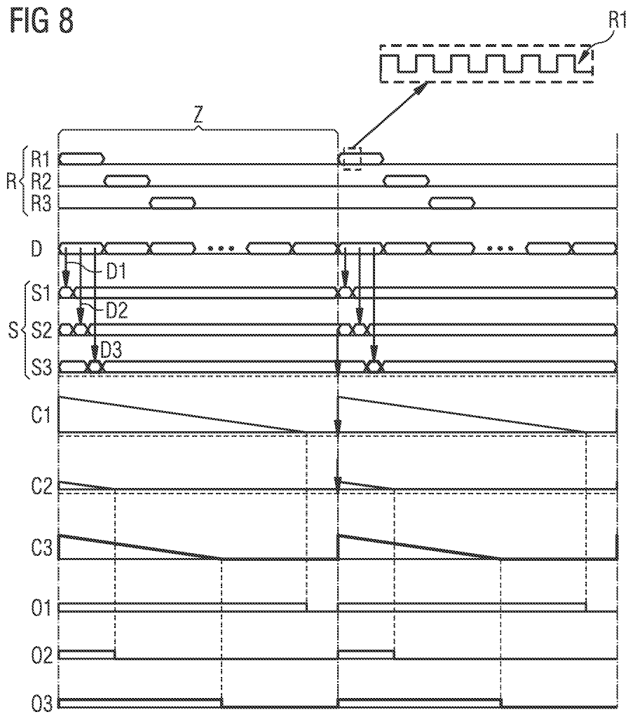

FIG. 8 an exemplary flow chart for operating the arrangement as shown in FIGS. 3-7;

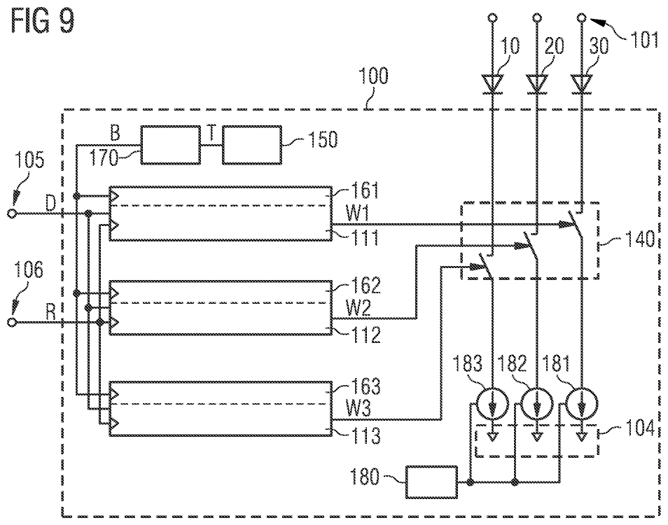

FIG. 9 a second exemplary embodiment of a control unit of the arrangement according to FIG. 3, 6 or 7 in detail view;

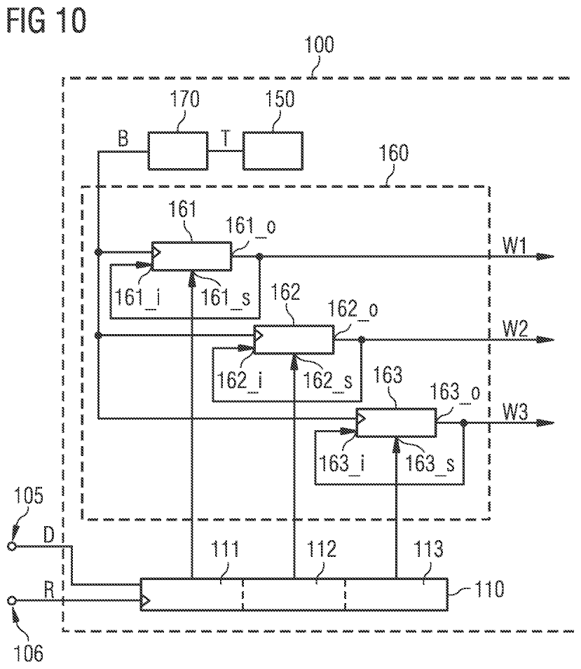

FIG. 10 a third exemplary embodiment of a control unit of the arrangement according to FIG. 3, 6 or 7 in detail view;

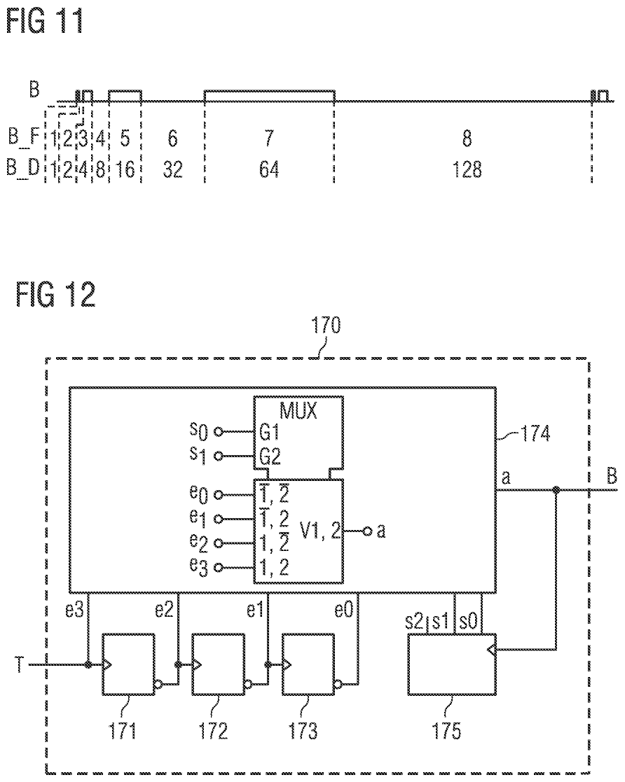

FIGS. 11-13 an exemplary PWM clock signal for operating the control unit according to FIG. 9 or 10 and a corresponding PWM clock generator for generating the PWM clock signal;

FIGS. 14-15 an examplary trigger signal for operating the control unit according to FIG. 9 or 10 and a corresponding logic circuit for generating the trigger signal;

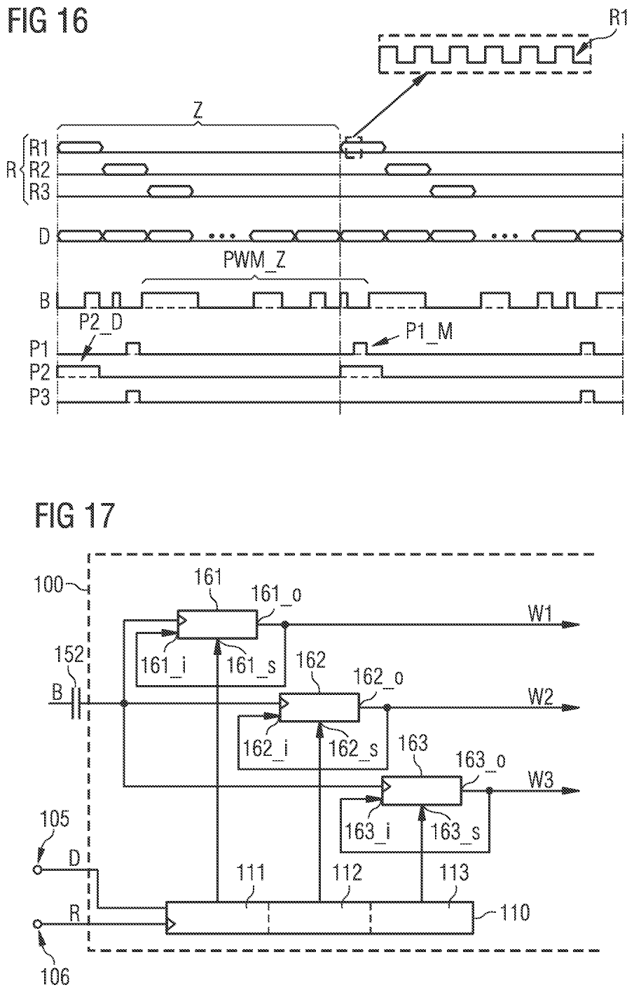

FIG. 16 an examplary flow chart for operating an arrangement with the control unit as shown in FIG. 9 or 10;

FIG. 17 a fourth exemplary embodiment of a control unit of the arrangement according to FIG. 3, 6 or 7 in detail view;

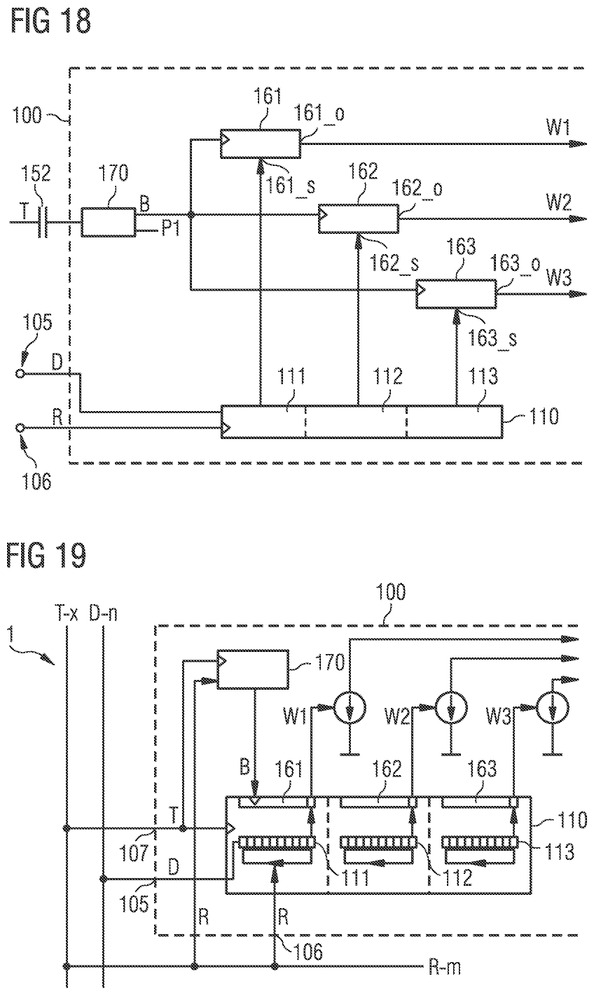

FIG. 18 a fifth exemplary embodiment of a control unit of the arrangement according to FIG. 3, 6 or 7 in detail view;

FIG. 19 a fourth exemplary embodiment of an arrangement for operating optoelectronic semiconductor chips;

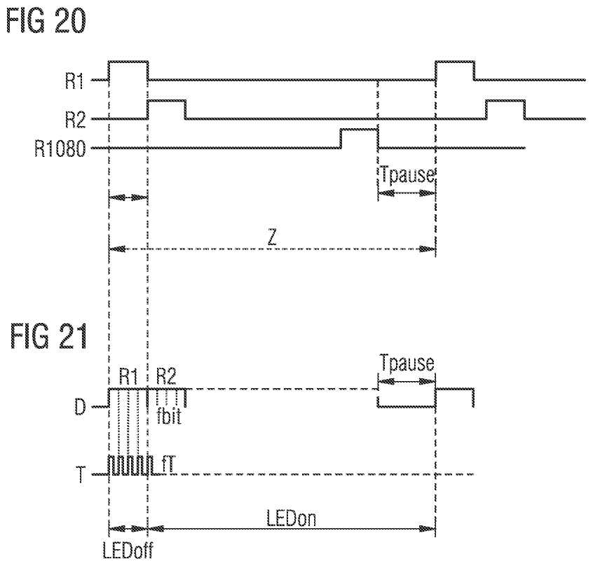

FIGS. 20-21 an exemplary section of a flowchart for operating the arrangement as shown in FIG. 19;

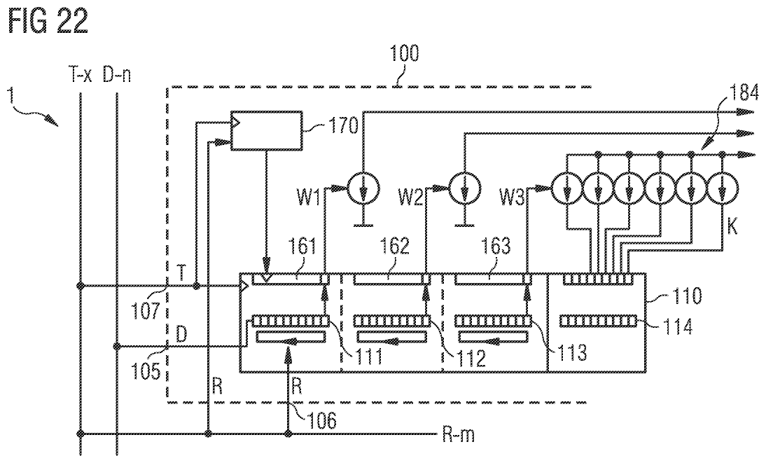

FIG. 22 a sixth exemplary embodiment of a control unit of the arrangement according to FIG. 3, 6, 7 or 19 in detail view;

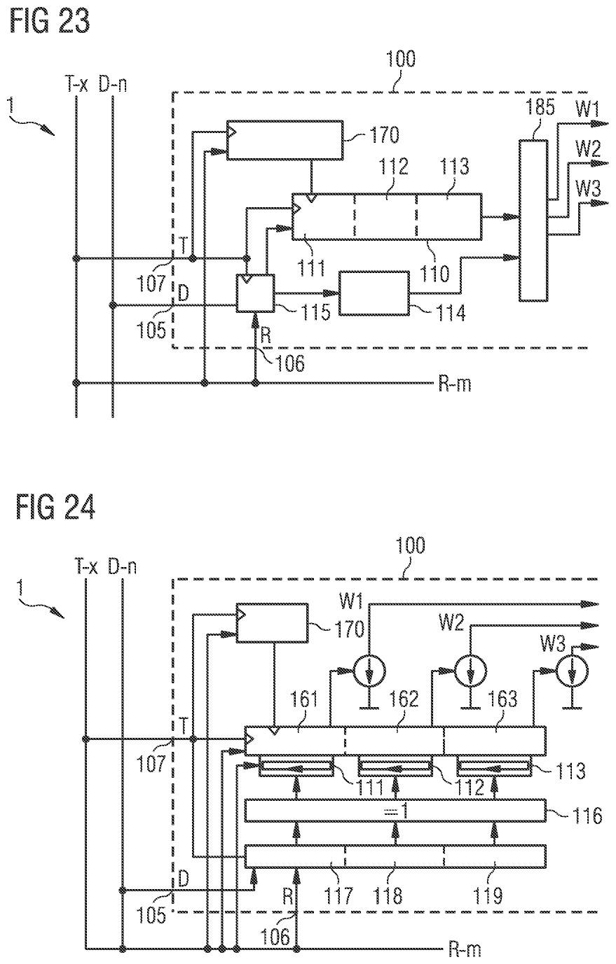

FIG. 23 a seventh exemplary embodiment of a control unit of the arrangement according to FIG. 3, 6, 7 or 19 in detail view;

FIG. 24 an eighth exemplary embodiment of a control unit of the arrangement according to FIG. 3, 6, 7 or 19 in detail view;

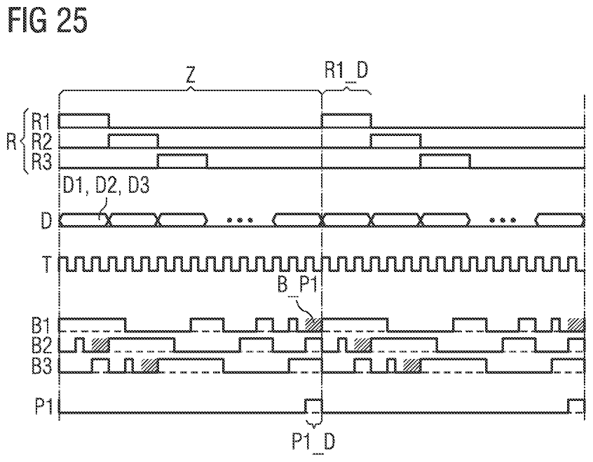

FIG. 25 an examplary flow chart for operating an arrangement with the control unit as shown in FIGS. 18 or 22 to 24;

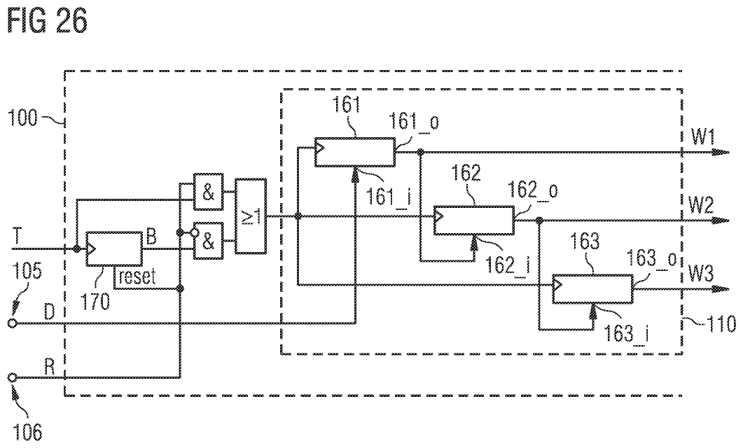

FIG. 26 a ninth exemplary embodiment of a control unit of the arrangement according to FIG. 3, 6, 7 or 19 in detail view; and

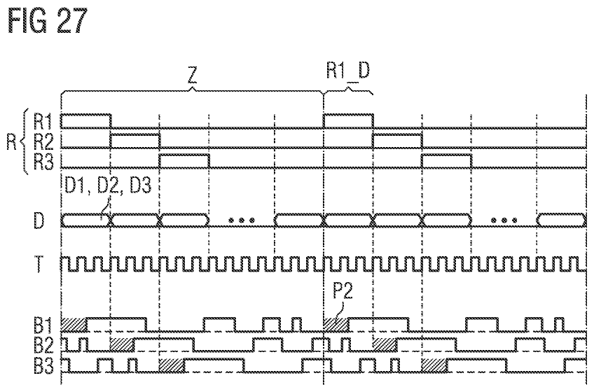

FIG. 27 an examplary flow chart for operating an arrangement with the control unit as shown in FIG. 26.

Elements of the same construction or function are provided with the same reference signs across all Figures.

A passive matrix circuit or an active matrix circuit can be used to drive display devices. Passive matrix circuits are common for the operation of so-called “LED displays”. With such display devices, only one line of a module lights up at a time, the corresponding LEDs must be supplied with a high current. In displays with active matrix circuits (FIG. 1), all picture elements are usually lit continuously. For this purpose, a capacitor 210 is usually used as an analog storage element in each picture element 200, but its charge is lost due to leakage currents.

FIG. 2 shows an exemplary display device 1 with n columns, m rows and m*n matrix-like arranged picture elements (in the following also called “pixels”, not shown here in detail). Each column is assigned a data line D-1, D-2, D-n for coupling with a column driver and each row is assigned a switching line R-1, R-2, R-m for coupling with a row driver. The rows can be electrically connected to each other via at least one row line per row. The column lines can be electrically connected via at least one column line per column.

In addition, the display device 1 may have further control lines or supply lines. Display device 1 also has connections for coupling a supply voltage, here schematically shown by means of a first and second supply line V_{DD}, Gnd. Further voltage supplies for electronics (e.g. 1.8V), especially for red LEDs (e.g. 2.5V) and green and blue LEDs (e.g. 3.5V) are possible. Several LED chips (e.g. red, green, blue) can be assigned to each pixel of display device 1.

For example, a video wall consists of several tiles. A tile can in turn contain several modules. The modules can be electrically connected and share common drivers. The tiles can also be electrically connected to each other and share common drivers. A video wall can have more than one column driver and more than one row driver. The display device 1 can be a video wall, a tile or a module, for example.

The programming of one row of display device 1 can be done in parallel, for example. For example, a driver can have 10 rows, 100 rows, 1080 rows or even 4320 rows. The column drivers can provide data signals for programming a row. A driver can contain 10 columns, 100 columns, 1980 or even 7680 columns.

FIG. 3 shows a first example of an arrangement 201 for operating such optoelectronic semiconductor chips. The arrangement 201, for example, forms a picture element of the display device 1 according to FIG. 2 and comprises five terminals.

The arrangement 201 comprises a first LED voltage input 101 for coupling with a first supply line V_{DD} of the display device 1, a reference voltage input 103 for coupling with a second supply line Gnd of the display device 1 and an IC voltage input 104 for coupling with an IC supply line V_{DD-IC} of the display device 1. Furthermore, the arrangement 201 comprises an LED data input 105 for coupling in terms of signalling with the data line D-n as well as a cycle input 106 for coupling in terms of signalling with the switching line R-m.

The arrangement 201 also has at least one control unit 100. Furthermore, the arrangement 201 comprises one or more optoelectronic semiconductor chips, which in this case are a red LED 10, a green LED 20 and a blue LED 30. The LEDs 10, 20, 30 are coupled by their first electrodes 11, 21, 31 to the first LED voltage input 101 and by their second electrodes 12, 22, 32 to the control unit 100. The control unit 100 is also coupled with the other inputs 103, 104, 105, 106 and is configured to control the LEDs 10, 20, 30, cf. FIG. 4 or 5. The control unit 100 is in particular a digital circuit (e.g. in CMOS or TFT technology).

In a first example of the control unit 100 (FIG. 4), it has a digital 24 bit memory 110, a counter 120, a comparator 130 and a switch 140. The memory 110 comprises a clock input, which is coupled in terms of signalling to the cycle input 106, and a data input, which is coupled in terms of signalling to the LED data input 105. For example, memory 110 comprises or forms a shift register that is configured for serial recording of a data parameter D via its data input. As an example, 8 bits of the data parameter D each form LED-specific data D1, D2, D3, which are representative of a current for operating one of the LEDs 10, 20, 30 each. For each LED 10, 20, 30 and/or each color channel, memory 110 can contain a separate memory unit. Depending on a reference cycle signal R received via cycle input 106, the data parameter D is written as memory value S into memory 110 or the memory units, respectively, and made available to downstream units via a data output. The memory value S thus comprises the LED-specific data D1, D2, D3 as LED-specific memory values S1, S2, S3.

In this exemplary embodiment, the memory value S is written as initial counter value C1, C2, C3 into the counter 120 downstream of memory 110 as a function of the reference cycle signal R for each LED 10, 20, 30. The counter 120 in turn has a clock input coupled to an internal reference clock generator 150 for generating a reference clock signal T (FIG. 4) or a reference clock input 107 of the arrangement 201 (FIG. 5), via which a reference clock signal T external with respect to the arrangement 201 can be provided.

Alternatively, the counter 120 can also be supplied with the reference clock signal T via a power supply line. The reference clock generator 150 includes, for example, a ring oscillator 151 and a capacitor 152, while the ring oscillator 151 can be a shortened ring oscillator with Schmitt trigger and RC delay element coupled to the first LED voltage input 101.

Counter 120 comprises, for example, a counting unit per LED 10, 20, 30 and/or color channel, which is configured to count down from the respective initial counter value C1, C2, C3. The current counter value C1, C2, C3 is always present at comparator 130. The comparator has a comparator unit for each counter value C1, C2, C3, which compares the respective counter value C1, C2, C3 with a predetermined final value, e.g. zero. If the current counter value C1, C2, C3 is not yet zero, the respective comparator unit outputs an output signal O1, O2, O3, which is representative of an illuminated operation of the corresponding LED 10, 20, 30. As soon as the current counter value C1, C2, C3 has reached zero, the respective comparator unit outputs an output signal O1, O2, O3, which is representative of switched-off operating state of the corresponding LED 10, 20, 30. In other words, the initial counter value C1, C2, C3 sets a pulse width of the current for operating the corresponding LED 10, 20, 30.

The output signal O1, O2, O3 controls for example a transistor as switch 140, which is configured to couple or decouple the second electrode 12, 22, 32 of the LEDs 10, 20, 30 with the power supply provided via the first and second supply line V_{DD}, Gnd. As an example, current sources 181, 182, 183 are connected downstream of switch 140 to impose a preset or controllable current intensity. A bias generator 180 may also be provided in this context.

The second exemplary embodiment of the arrangement 202 shown in FIG. 6 differs from the first exemplary embodiment in FIG. 3 in that the arrangement 202 has no IC voltage input 104 and therefore only four terminals. Instead, power is supplied to the arrangement 202 as well as to the LEDs 10, 20, 30 via the first LED voltage input 101. Accordingly, an IC supply line V_{DD-IC} of the display device 1 is not required. If the control unit 100 needs 1.8V and the LEDs 10, 20, 30 3V, an increased electrical loss occurs which reduces the efficiency. On the other hand, there is a simplified, low-cost wiring of the arrangement 202 in the display device 1.

The third exemplary embodiment of the arrangement 203, shown in FIG. 7, differs from the first exemplary embodiment in FIG. 3 in that the arrangement 203 has a second LED voltage input 102 and thus six terminals. Only the red LED 11 is coupled to the first LED voltage input 101, the green LED 20 and the blue LED 30 are coupled to the second LED voltage input 102 instead. Display device 1 has a second supply line V_{DD-GB} which is coupled to the second LED voltage input 102. The increased wiring effort is offset by the particularly high efficiency of arrangement 203.

In further, not shown exemplary embodiments, it is also conceivable that a image change takes place, for example, staggered row by row instead of simultaneously for all pixels of display device 1. Furthermore, a randomisation of the start times of counter 120 can be carried out to avoid load peaks in row or column drivers or the associated supply lines. It is also conceivable to provide a clock generator with a predetermined, fixed clock, from whose clock signal the reference cycle signal R and the reference clock signal T are derived. In addition, an address line may be provided in this case, which uniquely identifies the corresponding row where representative data parameters are present on the data line at the corresponding time.

FIG. 8 shows an exemplary flow chart for operating the arrangement as shown in FIGS. 3-7.

As an example, the reference cycle signal R1 is first provided on the first row of display device 1 via switching line R-1. Parallel to this, a data parameter D is provided serially for the first row via all data lines D-1, D-2, D-3, D-n, which includes digital data for each LED 10, 20, 30 as LED-specific data D1, D2, D3. The serial data is written into memory 110 or shifted over a shift register so that it is available in parallel in each pixel. If 8 bits per color and pixel are provided, for example, the red 8 bits can be written first, then the green 8 bits and finally the blue 8 bits. The data is then written to the other columns. At the end of a refresh cycle all data is rewritten and the respective counter 120 is written with the data from the respective memory 110. This can be done for all picture elements/rows at the same time or also time-shifted. The signal that ensures that the data is written from the respective memory 110 to the respective counter 120 can be generated as follows (not shown in detail)
supply from outside with an extra line;
decouple from outside via an existing line by capacitive decoupling (e.g. negative voltage pulse);
Alternatively, control unit 100 can include a further counter which e.g. counts up depending on the reference clock signal T. If this counter is e.g. (for 8 bit) at 255, the corresponding signal can be generated via an AND gate;
generate from the first rising edge of the reference cycle signal R.

Depending on the reference clock signal T the counter values C1, C2, C3 of counter 120 are counted down digitally. The output signals O1, O2 and O3 are set to zero when the counter values C1, C2, C3 have reached zero.

The data from memory 110 is written to counter 120 once per refresh cycle. Counter 110 counts down digitally with the reference clock signal T until it reaches zero. As long as the counter 120 is not at zero the corresponding LED chip 10, 20, 30 is lit.

If the refresh cycle duration is 10 ms (=100 Hz), a clock cycle time of 3.9 is results for a display device 1 with 192×108 pixels and 8 bits per color. This corresponds to a frequency of 0.3 MHz. Several display devices 1 can also be assembled as modules to form a larger display device. High refresh rates are desirable to obtain low flicker. A high data depth per color is desirable to achieve easy color and brightness calibration and high dynamic range. With a cycle time of 1 ms (=1,000 Hz), 16 bits per color and a display size of 1920×1080 pixels, a frequency of 51.8 MHz is required. To realize the control unit 100 in a silicon chip or TFT substrate, approximately 4,000 transistors are required. The area required for this depends on the technology used.

In the further exemplary embodiments described below, a control unit 100 is placed in each pixel, which is coupled to the first and second supply line V_{DD}, Gnd with voltage and ground, as well as via the data line D-n and the switching line R-m according to FIGS. 3, 6 and 7; further voltage supplies, data and clock signals are conceivable analogous to FIGS. 3, 6 and 7, which increases the number of contacts per pixel. It would also be conceivable that a control unit 100 drives several pixels, thus reducing the number of contacts (“pads”) on the control unit 100. Parts of the circuit could also be combined with it. As an example, for a display device 1 with four pixels instead of a single contact with 4*(3+3) pads=24 pins, a common contact with 4×3+3 pads=15 pins could be used. Since the pads often determine the chip size and costs for manufacturing the component are determined by the chip size, a combination can make sense. However, the more complex assembly and connection technology as well as high substrate costs have a disadvantage here. A structure of the control unit 100 according to the further exemplary embodiments is described below using FIGS. 9, 10, 17 and 18.

The idea here is to use a digital memory 110 in the control unit 100, which is filled via a serial data bus. As an example, this is again an input shift register. The memory 110 is as large as required for the color depth of the image and/or brightness correction of the LEDs 10, 20, 30 and/or global dimming (day/night); in particular, the capacity of the memory is 3 bits or more. Contrary to the previous examplary embodiments in accordance with FIGS. 4-8, each pixel is assigned a pulse-width generator (hereinafter PWM clock generator 170). It is also conceivable that several pixels share a PWM clock generator. For each color, the control unit 100 also has an output shift register (hereinafter shift register 160 or 161, 162, 163), which is clocked with the PWM clock generator 170.

In a second examplary embodiment of the control unit 100 (FIG. 9), it comprises a memory 110 with three memory units 111, 112, 113, a shift register 160 with three register units 161, 162, 163, a PWM clock generator 170, a reference clock generator 150 and a switch 140.

The switch 140 is again configured controllably to couple or decouple the second electrode 12, 22, 32 of LEDs 10, 20, 30 with the power supply provided via the first and second supply line V_{DD}, Gnd. As an example, current sources 181, 182, 183 are connected downstream of switch 140 to impose a preset or controllable current intensity. A bias generator 180 may also be provided in this context.

The memory units 111, 112, 113 each comprise a clock input, which is coupled in terms of signalling to the cycle input 106, and a data input, which is coupled in terms of signalling to the LED data input 105. For example, the memory units 111, 112, 113 are each designed as 8-stage input shift registers for this purpose, which are configured for serial recording of the data parameter D or the LED-specific data D1, D2, D3. Depending on a reference cycle signal R received via cycle input 106, the LED-specific data D1, D2, D3 are written as LED-specific memory values S1, S2, S3 into the memory units 111, 112, 113 and made available to downstream units via a data output. The memory units 111, 112, 113 may each be followed by an 8 bit flipflop, which in turn is coupled with one of the corresponding register units 161, 162, 163 of shift register 160. Alternatively the memory units 111, 112, 113 are directly coupled to the corresponding register units 161, 162, 163.

The register units 161, 162, 163 also have a clock input with which they are each coupled in terms of signalling to the PWM clock generator 170, which provides a PWM clock signal B. A data input of the register units 161, 162, 163 is coupled to the data output of the memory units 111, 112, 113 directly or indirectly via a flipflop, so that the memory values S1, S2, S3S can be recorded as initial shift values. The register units 161, 162, 163 are designed to shift the respective shift value bit by bit depending on the PWM clock signal B and to output it to downstream units via a data output as control value W1, W2, W3.

Depending on the respective control value W1, W2, W3, for example, switch 140 is again controlled to couple or decouple the second electrode 12, 22, 32 of LEDs 10, 20, 30 with the power supply provided via the first and second supply line V_{DD}, Gnd.

In this examplary embodiment the PWM clock generator 170 is coupled with an internal reference clock generator 150, which generates an internal reference clock signal T. The PWM clock generator 170 generates a PWM clock signal B from the reference clock signal T (cf. FIGS. 11-13). The PWM clock signal B has e.g. doubling pulse lengths B_D (cf. FIG. 11). Depending on the data depth (here 8 bits) there are more or less edges B_F (here 8 rising and falling edges) within one period. The shortest pulse stands for the LSB (last significant bit) and the longest pulse for the MSB (most significant bit). The PWM clock signal B is used to clock shift register 160. Via data input 105, data is written to memory 110 at the rate of the reference cycle signal R. The data from memory 110 can be written to shift register 160. The data is shifted from shift register 160 to the LED drivers via the PWM clock signal B. If the corresponding bit of the control value W1, W2, W3 is set, the LED 10, 20, 30 is lit, otherwise the corresponding LED 10, 20, 30 is not lit. In an advantageous way an asynchronous programming of the pixels can be realized with respect to an external programming. Synchronicity in this context means that frequency and phase of the external programming are equal to the PWM clock signal B.

In a third examplary embodiment of the control unit 100 (FIG. 10), memory 110 is directly coupled to shift register 160, so there is no need for a buffer like a flipflop. Furthermore, the memory units 111, 112, 113 form a unit of memory 110, which is exemplarily designed as a 16 stage input shift register and is configured to store 16 bits each for all three colors. The memory values S1, S2, S3 from memory 110 are written in parallel to set inputs 161_s, 162_s, 163_s of register units 161, 162, 163, depending on a trigger signal P3. The shift values at output 161_o, 162_o, 163_o of register units 161, 162, 163 are sequentially fed back to their input 161_i, 162_i, 163_i. In this way an asynchronous programming of the pixels with respect to an external programming can be realized in an advantageous way.

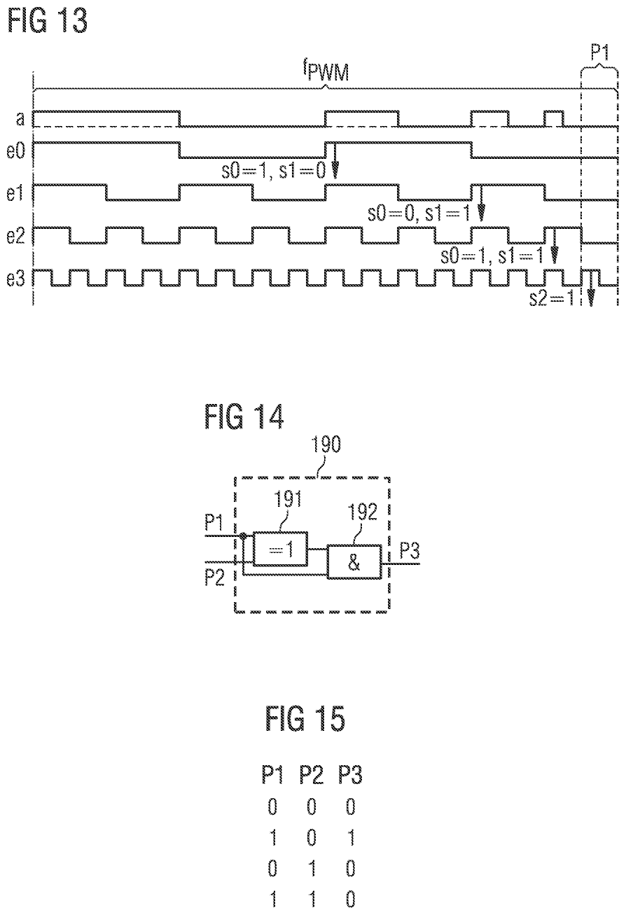

FIGS. 11-13 are used below to describe an example for generating the PWM clock signal B. The PWM clock generator 170 (FIG. 12) has an input for the reference clock signal T and an output for the PWM clock signal B. Furthermore, the PWM clock generator 170 includes several T-flipflops 171, 172, 173, to which the reference clock signal T is applied. This circuit corresponds to a digital frequency divider. Halved frequency signals are present at the branches e3, e2, e1 and e0. The signals e0, e1, e2 and e3 are applied to a multiplexer 174 on the input side. The multiplexer 174 initially lets the signal e0 pass via its output a, which is fed back into a counter 175. At the first rising edge of e0 the counter 175 at the output of the multiplexer 174 counts one up. The output s0, s1 of counter 175 is again coupled to a set input of multiplexer 174. Thus the multiplexer 174 switches on the output side from e0 to e1 (cf. FIG. 13). If the edge of e1 rises, the multiplexer 174 changes on the output side by incrementing counter 175 to e2, etc. The circuit can exist for 4 bit or also 16 bit and is therefore arbitrarily expandable.

The circuit is deliberately designed to start with the MSB, because the MSB is even. The LSB has the value 1 and is always odd. To keep the clock of the reference clock signal T and the clock of the PWM clock signal B synchronous, it is best to start with the MSB and not with the LSB. Since the last bit (LSB) has an odd value, another cycle is added to become synchronous again. This cycle can be advantageously used for programming of shift register 160. Since shift register 160 is undefined in this cycle, the LEDs 10, 20, 30 are off. If counter 175 has one more digit than necessary, a programming signal P1 (cf. FIGS. 14-16) can be generated. In the example two outputs s1 and s0 would be sufficient for counter 175 to generate the 4 bits. An additional output s2 can be given to a monoflop which has a hold time shorter than the cycle. Thus the programming signal P1 can be generated, which can be used to clear counter 175 and to program shift register 160.

With a PWM frequency of the PWM clock signal B of f_{PWM}=200 Hz the following applies: at 8 bit color depth the LEDs 10, 20, 30 are only in a switched off state in a tolerably short dead time of 1/256 of the time. The clock rate of the reference clock signal T should be 50 kHz. At 16 bit the clock rate of reference clock signal T increases to 13.1 MHz.

FIGS. 14-15 are used below to describe an example of how to generate the trigger signal P3. A circuit 190 is provided for this purpose (FIG. 14), comprising an exclusive-or-gate 191 and an AND-gate 192. The programming signal P1 described in FIGS. 11-13 is applied on the input side to both the exclusive-or-gate 191 and the AND-gate 192. Furthermore, an external programming signal P2 is applied to the input side of the exclusive-or-gate 191, which is provided externally with respect to the arrangement 201, 202, 203 and is representative of a point in time when data is written from outside into shift register 160. An output of the exclusive-or-gate 191 is connected to the input side of And-gate 192. On the output side, the AND-gate 192 provides the trigger signal P3. It is advantageous to prevent incorrect programming of shift register 1609 by generating the trigger signal P3, especially in asynchronous external programming.

FIG. 15 shows the corresponding output value of the trigger signal P3 depending on the corresponding input values of the programming signals P1, P2.

FIG. 16 shows an asynchronous programming of control unit 100 as shown in FIG. 10, using an exemplary time diagram. The reference cycle signal R1 comprises a square wave signal with a frequency of 3.2 MHz (corresponding to a data rate of 3*16 bit /15 μs=1/0.31 μs) during programming of the corresponding row of display device 1. This means that the data parameter D can comprise 16 bits for each color, which are written into the pixel via the corresponding data line D-1, D-2, D-3. The programming of further rows via the switching lines R-2, R-3, etc. is then carried out. The internally generated PWM clock signal B may have a different frequency of 200 Hz (internal PWM cycle PWM_Z −5 ms) and an unbalanced phase to the external programming frequency of the external programming signal P2. The internal programming signal P1 includes exemplary monoflops P1_M of 1 μs and indicates when data from memory 110 can be written into shift register 160. The external programming signal P2 (duration P2_D e.g. 16.7 ms/1080 rows=15 μs) indicates when data from outside is written into shift register 160. To avoid undefined states, it may be preferable to avoid writing to memory 110 during the programming of shift register 160, so that incomplete data in memory 110 can be avoided. To ensure this, the trigger signal P3 is generated from the programming signals P1 and P2 according to circuit 190 (see FIG. 14).

So it may happen that new data parameter D is available externally but cannot be written into shift register 160. To keep this case as rare as possible, the frequency of the internal programming is chosen higher, e.g. 200 Hz, than the external programming, e.g. 60 Hz (corresponds to the cycle duration Z˜17 ms). The probability that the programming signals P1 and P2 coincide can be kept low if both duty cycles are very high. As an example, the programming signal P1 has a duration P1_M=1 μs and a duty cycle of 1:5000 and the programming signal P2 has a duration P2_D=15 μs and a duty cycle of 1:1080.

FIGS. 17 and 18 show further exemplary embodiments of control unit 100. The control unit 100 in the fourth exemplary embodiment according to FIG. 17 differs from the control unit 100 according to FIG. 10 in that the PWM clock signal B is not generated internally but is supplied externally. It can be supplied via an extra pin/line or by modulation to another signal, such as the supply voltage via the V_{DD} supply line. In this case the signal can be decoupled via a capacitor 152. In an advantageous way an asynchronous programming of the pixels can be realized with respect to an external programming.

The control unit 100 in the fifth exemplary embodiment according to FIG. 18 differs from the control units 100 according to FIGS. 10 and 17 in the synchronicity of the programming. A reference clock signal T is supplied externally with respect to control unit 100. Analogous to the control unit 100 according to FIG. 17, this can also be done directly via a pin or indirectly via a capacitor 152. The reference clock signal T feeds the PWM clock generator 170, which is reset/synchronized by the reference cycle input 106 as program clock. As in the previous exemplary embodiments, the programming signal P1 is generated by the PWM clock generator 170. A feedback of the data at shift register 160 from output 161_o, 162_o, 163_o to the corresponding input 161_i, 162_i, 163_i (cf. FIGS. 10 and 17) is only optional in this case, however, because there are never cases in which internal programming is prohibited, since the programming processes are synchronous. The data are therefore always available in full. In contrast to FIGS. 10 and 17, the memory values S1, S2, S3 from memory 110 are here written in parallel to the set inputs 161_s, 162_s, 163_s of register units 161, 162, 163, depending on the programming signal P1 instead of the trigger signal P3. In a particularly advantageous way, synchronous programming of the pixels with respect to external programming can be realized. By using adapted clock rates, it is advantageous to create a fully synchronous scheme. This allows bit rates to be displayed with the best possible resolution.

FIGS. 19 to 21 show a fourth exemplary embodiment of an arrangement for operating optoelectronic semiconductor chips and exemplary sections of a flow chart for operating this arrangement. The control unit 100 is essentially the same as the control unit shown in FIG. 18. Arrangement 1 essentially corresponds to the arrangements in FIGS. 3, 6 and 7, but in contrast to these it also has a reference clock line T-x, which is connected to reference clock input 107 of control unit 100.

The LEDs are only activated by the control values W1, W2, W3 if the reference cycle signal R, R1, R2, R1080 is deactivated (cf. FIG. 20). This allows a maximum duty cycle of >99% to be achieved. If the reference cycle signal R is deactivated, the PWM clock generator 170 can be reset. When the reference cycle signal R is active, for example, 10 bits can be loaded into the memory units 111, 112, 113 at the rate of the reference cycle signal T. Furthermore, when the reference cycle signal R is active, the PWM clock signal B is used as a clock in the memory units 111, 112, 113; i.e. the 10-bit memory value is circulated for each color (e.g. red, green or blue). The current LSB or MSB, depending on the charging direction, is actively transmitted to a switch (FET) such as switch 140 mentioned above, which draws the required current at the corresponding LED as a digital PWM signal. During a refresh cycle this 10-bit cycle can be run through several times. This enables better playback quality, e.g. for video recordings. Compared to a counter, the PWM clock generator 170 allows a suitable mix (“scramble”) of switched on and off operating phases of the LEDs.

FIG. 20 shows the individual reference cycle signals R1, R2, R1080 for operating arrangement 1 with positive logic. Alternatively, inverting logic can also be used. The pause Tpause may be required to synchronize bit rates/resolution (bit) and the clock of the reference clock signal T. This allows several arrangements 1 to be operated with the same global reference clock signal T without the need to generate a separate clock for loading the data or similar. For example, the cycle duration Z can be 1/fframe, where fframe is the frame rate of the arrangement 1.

FIG. 21 shows the data parameter D and the reference clock signal T within the cycle duration Z. Within the active reference cycle signal R1 the corresponding memory 110 is written to, the LEDs are accordingly in a switched off state LEDoff. Subsequently, the LEDs are set to a switched-on LEDon state and pulsed by means of the PWM clock signal B. The frequency fT of the reference clock signal T is twice as high as the bit repetition rate fbit of the data parameter D.

To operate arrangement 1, no PWM pulses are applied to the supply voltage of the LEDs. Instead, a global reference clock signal T can be supplied, depending on which a local digital PWM clock signal B can be generated per pixel. Only one pulse of the reference clock signal per bit is required. The data parameters D loaded per image do not have to be written again after each cycle, rather the loaded data parameters D can be run through cyclically more often.

FIGS. 22 to 24 show further exemplary embodiments of a control unit of the arrangement shown in FIG. 3, 6, 7 or 19. Compared to the previous exemplary embodiments, the control unit 100 is here extended by an analogue dimming option. The features described in FIGS. 22 to 24 can also be applied to the previous examples and vice versa.

As an example, memory 110 includes a further memory unit as dimming memory area 114 for recording a dimming parameter K (FIG. 22). The dimming parameter K, for example, comprises 6 bits per LED, e.g. 18 bits in the present case. For example, the dimming parameter K is loaded at the beginning into the dimming memory area 114, which is not supplied by the PWM clock signal B. Control unit 100 also includes six current sources 184 per LED (shown here for the sake of clarity for one string only), which are connected in series and scaled in the ratio 1:2:4:8:16:32. Depending on the dimming parameter K, the individual current sources 184 are controlled to dim the LEDs analogously. In this context, the data parameter D can have a 16 bit total resolution.

On control unit 100 as shown in FIG. 23, the dimming memory area 114 is separate from memory 110. This makes it possible, for example, to implement a high-resolution, dimmable or calibrateable display device that can be operated with a data parameter D that satisfies a predetermined maximum number of bits. By separating the charged bits, a mix of analog dimming via the diode current and simultaneous pulse width modulation is possible. Thus, the data parameter D can comprise either a grey value, for example 10 bit, or a dimming value, for example 18 bit. The grey value is loaded into the memory units 111, 112, 113 in the same way as in the previous exemplary embodiments. The dimming value is loaded into the dimming memory area 114. The register into which the data parameter D is loaded is determined, for example, by a voltage level applied to control unit 100. For example, the voltage level of the reference clock signal T, the reference cycle signal R, the data parameter D, or the supply voltage V_{DD} can be reduced to indicate that the data parameter D describes a dimming value. In this context, control unit 100 has a selector 115 as an example, which analyses the corresponding voltage level and writes the data parameter D into the correct register. For example, if the above voltage level is reduced by about half compared to a standard voltage level, the data parameter D is written to the dimming memory area 114 while the reference cycle signal R is active, i.e. during the charging process as described in the previous examples. A large time interval between the individual write phases of the dimming memory area 114 can be selected. In other words, a voltage-dependent selection of data can be realized, e.g. to distinguish long-term (dimming/calibration) data from short-term (image) data. The individual current sources 184 (cf. FIG. 22) are combined here in a driver circuit 185.

As an example, two variants of reference cycle signals R can be used to operate arrangement 1 with such a control unit 100 according to FIG. 23. Analogous to the previous exemplary embodiments, the reference cycle signal R in the first variant can, for example, comprise 30 cycles of the reference clock signal T to quickly renew the 10 bits per LED. In a second variant, the reference clock signal R comprises, in addition to the 30 cycles for renewing the 10 bits per LED, a further 18 cycles of the reference clock signal T for renewing the 6 bits per LED for the slow dimming or calibration mode.

FIG. 24 shows an eighth exemplary embodiment of a control unit 100, which differs from the previous exemplary embodiments in that an exclusive-or-gate 116 and an additional memory with memory units 117, 118, 119 are located upstream of memory 110. Furthermore, arrangement 1 is operated here with a so-called “delta modulation”, i.e. the data parameter D is only described with changes with respect to the previous data parameter D during operation of arrangement 1, so that a reduced data rate is possible. The changes of the data parameter D are first written to the additional memory units 117, 118, 119. A link to the previous data parameter D is established via the exclusive-or-gate 116. For example, the respective old memory value S1, S2, S3 is only changed in data parameter D in the case of a new “1” (with positive logic; to keep bus loads low, “0” is recommended for negative logic). The renewal takes place at the end of a pulse of the reference cycle signal R. This allows flexible data rates. Such an operation can be transferred to the time sequence of the previous exemplary embodiments, but in contrast to this, only the bit(s) that change from frame to frame are transferred.

Finally, the time diagram in FIG. 25 shows the exemplary synchronous programming of control unit 100 as shown in FIGS. 18 and 22 to 24. The reference cycle signal R1, unlike in the time diagram in FIG. 16, has no submodulation; instead, a reference clock signal T is supplied separately. The data parameter D again comprises 3×16 bit LED-specific data D1, D2, D3. The frequency of the reference clock signal T of 3.2 MHz is identical to the frequency of the submodulation of the reference cycle signal R1 in the time diagram of FIG. 16 (for a simplified representation only 3 bits instead of 3*16 bits are shown here). The programming of the second row of display device 1 is delayed by a programming time of the duration R1 _D of 15.5 μs compared to the first row. This time is required to program 1080 rows of display device 1 at a frequency of 60 Hz of external programming (corresponds to the cycle duration Z 16.7 ms). At the end of the cycle of the corresponding PWM clock signal B1 (for simplified representation, only 4 bits instead of 16 bits are shown here) of 16.7 ms, the PWM clock generator 170 generates the programming signal P1 with a duration P1 _D of 0.31 μs (highlighted here as signal B_P1). The data from memory 110 is then written to shift register 160 for the next clock pulse.

FIGS. 26-27 show a ninth exemplary embodiment of a control unit of the arrangement shown in FIG. 3, 6, 7 or 19, as well as an exemplary flow chart for its operation. In contrast to the control units shown in FIG. 9, 10, 17 or 18, a memory 110 consisting of only three shift registers 161, 162, 163 is used here, which helps to further simplify the circuit. Further memory/shift registers or counters can be dispensed with advantageously. The LED-specific data D1, D2, D3 are shifted into the individual shift registers 161, 162, 163 with the clock of the reference clock signal T when the reference cycle signal R is active. Then, with the reference cycle signal R inactive, the clock input of shift registers 161, 162, 163 is switched to the PWM clock signal B. At the rate of the PWM clock signal B, the memory values S1, S2, S3 are shifted out of the shift registers 161, 162, 163 and output bit by bit as control values W1, W2, W3. In order to ensure the changeover, the PWM clock generator 170 can be coupled to the input of an AND-gate on the output side as an example. A second input of the AND-gate provides the reference cycle signal R negated. The reference cycle signal R is also applied to the input of a further AND-gate. The reference clock signal T is also present at a second input of the further AND-gate. The outputs of the two AND-gates are connected to an OR-gate whose output is coupled to the clock input of shift registers 161, 162, 163. The reference cycle signal R is also used to reset the PWM clock generator 170.

In summary, the display device 1 or control unit 100 according to FIGS. 9-27 allows a low data bandwidth, simple (synchronous) active pixel control. Furthermore, a contribution is made to low component costs. Especially a number of control lines can be kept low.

The invention is not limited to the exemplary embodiments by the description. Rather, the invention includes each new feature and each combination of features, which in particular includes each combination of features in the patent claims, even if that feature or that combination itself is not explicitly stated in the patent claims or exemplary embodiments.

### LIST OF REFERENCE SIGNS

1 display device

10, 10′, 20, 30 semiconductor chip

11, 12, 21, 22, 31, 32 electrodes

100 control unit

101, 102 LED voltage input

103 reference voltage input

104 IC-voltage input

105 LED data input

106 Cycle input

107 reference clock input

110, 111, 112, 113 memory

114 dimming memory area

115 selector

116 exclusive-or-gate

117, 118, 119 memory

120 counter

130 comparator

140 switch

150 reference clock generator

151 ring oscillator

152 capacitor

160, 161, 162, 163 shift register

161_i, 162_i, 163_i input

161_o, 162_o, 163_o output

161_s, 162_s, 163_s set input

170 PWM clock generator

171, 172, 173 flipflop

174 multiplexer

175 counter

180 bias generator

181, 182, 183, 184 current source

185 driver circuit

190 logic circuit

191 exclusive-or-gate

192 and-gate

200 aktiv-matrix circuitry

201, 202, 203 arrangement

210 capacitor

220, 230 transistor

D-1, D-2, D-n data line

R-1, R-2, R-m switching line

T-x reference clock line

V_{DD}, V_{DD-IC}, V_{DD-GB}, Gnd supply line

D, D1, D2, R3 data parameter

R, R1, R2, R3, R1080 reference cycle signal

S, S1, S2, S3 memory value

K dimming parameter

T, T1, T2, T3 reference clock signal

C1, C2, C3 counter value

O1, O2, O3 output signal

B, B1, B2, B3 PWM clock signal

B_F Edge number

B_D pulse length

W1, W2, W3 control value

Z cylcle length

PWM_Z PWM cycle

P1_M monoflop

P1_D, P2_D, R1_D duration

B_P1 signal

f_{PWM} frequency

e0, e1, e2, e3 input

a output

s0, s1, s2 set input

P1, P2 programming signal

P3 trigger signal

1. An arrangement for operating optoelectronic semiconductor chips, comprising
a first semiconductor chip having a first and second electrode and configured to emit electromagnetic radiation during operation,
a control unit for adjusting a current for operating the first semiconductor chip,
a first LED voltage input coupled to the first electrode of the first semiconductor chip, and a reference voltage input coupled to the second electrode of the first semiconductor chip via the control unit,
an LED data input coupled to the control unit and via which a data parameter can be provided which is representative of a current for operating the first semiconductor chip, and
a cycle input, which is coupled to the control unit and via which a reference cycle signal can be provided which is external with respect to the arrangement and representative of an operating phase of the arrangement, wherein
the control unit comprises a memory which has a storage capacity >3 bits and is configured to record the data parameter as a memory value depending on the reference cycle signal, and
the control unit is configured to adjust the current for operating the first semiconductor chip depending on the memory value.

2. (canceled)

3. The arrangement according to claim 1, wherein
the control unit comprises a counter per semiconductor chip, having a clock input via which a reference clock signal can be provided, and a data input which is coupled to the memory, the counter being configured to take an initial counter value in each case depending on the memory value, and to count with the respective counter value depending on the reference clock signal up to a predetermined final value, and
the control unit is configured to adjust the current for operating the respective semiconductor chip depending on the corresponding counter value.

4. The arrangement according to claim 3, comprising a comparator and a switch per semiconductor chip, wherein the comparator is coupled to the respective counter and configured to compare the respective counter value with the predetermined final value, wherein
in case the predetermined final value has not yet been reached, the control unit is configured to set the switch to a first switching state, and
in case that the predetermined final value has been reached, the control unit is configured to set the switch to a second switching state, wherein
the switch is arranged, depending on the respective switching state, to couple or decouple the respective second electrode of the semiconductor chips to or from the reference voltage input and thus adjust the current for operating the respective semiconductor chip.

5. The arrangement according to claim 3, wherein
the control unit comprises a reference clock generator for generating the reference clock signal, which is coupled to the clock input of the respective counter, or
the arrangement comprises a reference clock input which is coupled to the clock input of the respective counter and via which a reference clock signal can be provided which is external with respect to the arrangement.

6. The arrangement according to claim 1, wherein the control unit has a supply input, and
the supply input is coupled to the first LED voltage input, or
the arrangement comprises an IC voltage input, and the supply input is coupled to the IC voltage input.

7. The arrangement according to claim 1, where
the control unit comprises per semiconductor chip a shift register having a clock input via which a PWM clock signal can be provided, a data input which is coupled to the memory, and a data output, wherein the shift register is configured to receive an initial shift value in each case depending on the memory value, to shift the respective shift value bit by bit depending on the PWM clock signal and to output it as a control value via the data output, and
the control unit is configured to adjust the current for operating the respective semiconductor chip depending on the corresponding control value.

8. The arrangement according to claim 7, comprising a switch per semiconductor chip , which is coupled to the data output of the respective shift register, wherein the control unit is configured to set the switch into a first or second switching state depending on the control value, wherein
the switch is configured, depending on the respective switching state, to couple or decouple the respective second electrode of the semiconductor chips to or from the reference voltage input and thus to adjust the current for operating the respective semiconductor chip.

9. The arrangement according to claim 7, wherein
the arrangement comprises a PWM clock input which is coupled to the clock input of the respective shift register and via which a PWM clock signal can be provided, which is external with respect to the arrangement or
the control unit comprises a PWM clock generator having a clock input via which a reference clock signal can be provided, wherein the PWM clock generator is coupled to the clock input of the respective shift register and configured to generate the PWM clock signal depending on the reference clock signal.

10. The arrangement according to claim 9, wherein
the control unit comprises a reference clock generator for generating the reference clock signal, which is coupled to the clock input of the PWM clock generator, or
the arrangement comprises a reference clock input which is coupled to the clock input of the PWM clock generator and via which a reference clock signal can be provided which is external with respect to the arrangement.

11. The arrangement according to claim 7, wherein the shift register is configured as a circular shift register.

12. Arrangement according to claim 7, wherein the control unit is configured to determine a control signal depending on the PWM clock signal and the reference cycle signal, and to reset the shift value and record the memory value as a respective initial shift value in the corresponding shift register depending on the control signal.

13. The arrangement according to claim 1, wherein
the data parameter comprises a dimming parameter for operating the respective semiconductor chip,
the memory has a dimming memory area for receiving the dimming parameter,
the control unit is configured to scale the current for operating the respective semiconductor chip depending on the dimming parameter.

14. The arrangement according to claim 13, wherein the control unit is configured to detect a voltage level present at the first and/or second LED voltage input, at the cycle input and/or at the reference clock input, and in the event of a predetermined deviation of the voltage level from a predetermined standard operating voltage level, to record a data parameter present at the LED data input as dimming parameter in the dimming memory area.

15. The arrangement according to claim 1, wherein
the memory comprises an input memory unit,
the input memory unit is coupled on the input side to the LED data input for receiving the data parameter as a buffer value,
the input memory unit is coupled on the output side via an exclusive-or-gate to an input of the output memory unit for outputting the buffer value,
the output memory unit is configured to receive the buffer value output via the exclusive-or-gate as memory value and to provide it on the output side for operating the respective semiconductor chip.

16. The arrangement according to claim 1, wherein
the memory forms a shift register per semiconductor chip, having a clock input via which a PWM clock signal can be provided, a data input for receiving the data parameter as memory value and a data output, wherein the shift register is configured to shift the memory value bit by bit depending on the PWM clock signal and to output it as control value via the data output, and
the control unit is configured to adjust the current for operating the respective semiconductor chip depending on the corresponding control value.

17. A display device comprising a plurality of arrangements according to claim 1, arranged in rows and columns in a matrix-like manner, a first and second supply line and a data line per column and a switching line per row, wherein
the arrangements are each coupled by their first LED voltage input to the first supply line and by their reference voltage input to the second supply line, and
the arrangements are each coupled by their LED data input to the respective data line and by their cycle input to the respective switching line.

18. (canceled)

19. The display device according to claim 17, comprising at least one PWM clock generator for providing a PWM clock signal, the at least one PWM clock generator being associated with one or more arrangements respectively.

20. The arrangement according to claim 9, wherein
the PWM clock generator comprises one or more flipflops connected in series, a multiplexer and a counter,
the multiplexer has at least one control input, at least two inputs and one output,
the one or more flipflops connected in series are configured to output a clock pulse present on the input side halved on the output side,
the one flipflop is coupled to the reference clock signal and to a first input of the multiplexer on the input side and to a second input of the multiplexer on the output side, or a first of the plurality of flipflops is coupled to the reference clock signal and the first input of the multiplexer on the input side and to an input of a second flipflop of the plurality of flipflops and to a second input of the multiplexer on the output side, the second flipflop being coupled in turn on the output side to a further input of the multiplexer or to a plurality of further inputs of the multiplexer and flipflops,
the output of the multiplexer is coupled to a clock input of the counter and is representative of the PWM clock signal,
the counter is configured to increment a control signal present at the at least one control input in binary form depending on the PWM clock signal.

21. An arrangement for operating optoelectronic semiconductor chips, comprising
a first semiconductor chip having a first and second electrode and configured to emit electromagnetic radiation during operation,
a control unit for adjusting a current for operating the first semiconductor chip,
a first LED voltage input coupled to the first electrode of the first semiconductor chip, and a reference voltage input coupled to the second electrode of the first semiconductor chip via the control unit,
an LED data input coupled to the control unit and via which a data parameter can be provided which is representative of a current for operating the first semiconductor chip, and
a cycle input, which is coupled to the control unit and via which a reference cycle signal can be provided which is external with respect to the arrangement and representative of an operating phase of the arrangement, wherein
the control unit comprises a memory which has a storage capacity >3 bits and is configured to record the data parameter as a memory value depending on the reference cycle signal,
the control unit is configured to adjust the current for operating the first semiconductor chip depending on the memory value,
the first semiconductor chip is configured to emit red light, and the arrangement further comprises:
a second semiconductor chip having a first and second electrode and configured to emit green light during operation,
a third semiconductor chip having a first and second electrode and adapted to emit blue light during operation; and
a second LED voltage input coupled respectively to the first electrode of the second and third semiconductor chips, the reference voltage input being coupled respectively via the control unit to the second electrode of the semiconductor chips, wherein
the data parameter is representative of a current for operating the respective semiconductor chip, and
the control unit is configured to adjust the current for operating the respective semiconductor chip depending on the memory value.

22. A display device comprising a plurality of arrangements according to claim 1, arranged in rows and columns in a matrix-like manner, a first and second supply line and a data line per column and a switching line per row, wherein
the arrangements are each coupled by their first LED voltage input to the first supply line and by their reference voltage input to the second supply line, and
the arrangements are each coupled by their LED data input to the respective data line and by their cycle input to the respective switching line, and
the display device further comprising a third supply line, wherein
the arrangements are each coupled by their second LED voltage input to the third supply line.
